(19) United States
(12) Patent Application Publication
(10) Pub. No.: US 2012/0045213 A1
(43) Pub. Date: Feb. 23, 2012

(54) TIME DIVISION MULTIPLEXING TRANSMISSION SYSTEM AND METHOD OF CONTROLLING SYSTEM OF SAME

(75) Inventor: Masayuki Miura, Tokyo (JP)

(73) Assignee: Furukawa Electric Co., Ltd., Tokyo (JP)

(21) Appl. No.: 13/201,840

(22) PCT Filed: Feb. 15, 2010
(86) PCT No.: PCT/JP2010/052155

§ 371 Date: Sep. 28, 2011

(30) Foreign Application Priority Data
Feb. 17, 2009 (JP) 2009-033440

(51) Int. Cl. H04J 14/08

(52) U.S. Cl. 398/98

(57) ABSTRACT

There is provided a time division multiplexing transmission system which is capable of increasing the transmission efficiency. The system comprises OLT 10 and ONUs 20 connected to the OLT on a point-to-multipoint basis. The OLT 10 comprises a transmission circuit 11 that transmits a signal to the ONUs 20, a receiving circuit 12 that receives a signal from the ONU, and a transmission and receiving control circuit 13 that controls transmission and reception of a signal by the circuit 11 and the circuit 12. The OLT 10 specifies the transmission speed of an ONU device to be connected with itself, transmits the specified transmission speed to the ONU devices, and changes the settings of the circuit 12 based on that transmission speed. The ONU 20 transmits a response frame to the circuit 12 when the transmission speed transmitted from the circuit 11 agrees with its own transmission speed.

### FIELD OF THE INVENTION

The present invention relates to a time division multiplexing transmission system and a method of controlling the system. In particular, the present invention relates to a time division multiplexing transmission system of a point-to-multipoint type comprising a center-side optical line terminal device and a plurality of user-side optical network unit devices and a method of controlling the system.

### BACKGROUND ART

In a conventional Time Division Multiplexing transmission (TDM) system shown in FIG. 8, a center-side Optical Line Terminal (OLT) device is connected to user-side Optical Network Unit (ONU) devices on a point-to-multipoint basis. In the conventional system, ONU devices with an upstream transmission speed (speed at which the ONU devices transmit signals to the OLT device) of 1.25 Gp/s and ONU devices with an upstream transmission speed of 10.3125 Gp/s coexist.

FIG. 9 is a diagram schematically showing a configuration of the OLT device in FIG. 8. Specifically, FIG. 9A shows a configuration of a receiver of the OLT device; FIG. 9B shows a configuration of a postamplifier (LA); and FIG. 9C shows a configuration of a preamplifier (TIA).

In the OLT device in FIG. 9, light is received by an Avalanche PhotoDiode (APD), which is a light-receiving device, and amplified by a Trans-Impedance Amplifier (TIA), which is a preamplifier, and a differential electrical output is subsequently split. One of the split electrical outputs is amplified by a Limiting Amplifier (LA), which is a postamplifier for 1 G, and the other is amplified by an LA for 10 G. The output side of each LA is connected with a Bit-rate Discrimination Circuit (BDC). This BDC determines whether a 1 G signal is output in response to an output from the LA for 1 G and whether a 10 G signal is output in response to an output from the LA for 10 G. When the determination result shows that an effective signal is output, a Gate Circuit (GC), which is connected with the output side of each LA, outputs a signal. (See, e.g., Kazutaka Hara, A 1.25/10.3-Gbit/s AC-coupled Dual-rate Burst-mode Receiver without Reset Signals, 34th European Conference and Exhibition on Optical Communication (Belgian), Sep. 21-25, 2008, We2F1.)

However, in the aforementioned technique, a differential output of the preamplifier (TIA) is split, and each split output is transmitted to Gate Circuits (GC) adapted to different transmission speeds. Accordingly, an output downstream from the preamplifier is a single output. In general, advantages of a differential output over a single output are reduced common mode noise, smaller changes in power source signals, and lower Electro Magnetic Interference (EMI) of digital signals from output lines. As can be seen in the aforementioned technique, these advantages are compromised by splitting a differential output, thereby producing adverse effects on the performance, e.g., deterioration of receiving sensitivity.

Also, as a general preamplifier (TIA) only produces a pair of differential outputs, it can only adapt to two transmission speeds. This problem can be solved by disposing an IC for splitting outputs on the output side of the TIA. However, when the IC structure is simple and the output amplitude of the TIA changes due to changes in the optical input level, duty changes in the output amplitude, degradation of receiving sensitivity due to waveform distortions, and a reduced response speed for a burst response signal occur. Increased complexity of a circuit configuration leads to an increase in the cost, size, and power consumption.

In addition, as the transmission speed is determined based on a signal received by the BDC, a determination signal for determining the transmission speed is needed, and it takes time to make such a determination. In particular, when one of the two transmission speeds is an integer multiple of the other, the determination is difficult as their data patterns are similar, and it takes a large amount of time to make that determination. Also, as a determination signal (ID) needs to be added at the beginning of each signal in order to make the aforementioned determination, the time allocated for transmitting effective data per unit time decreases, whereby the overall transmission efficiency of the system decreases.

Furthermore, as a Bit-rate Discrimination Circuit (BDC) for determining a transmission speed is needed, the cost, size, and power consumption increase.

### SUMMARY OF THE INVENTION

### Problem to be Solved by the Invention

The object of the present invention is to provide a time division multiplexing transmission system which is capable of increasing the transmission efficiency while restraining deterioration of receiving sensitivity and prevent the cost, size, and power consumption from increasing as well as a method of controlling the system.

To attain the above object, in a first aspect of the present invention, a time division multiplexing transmission system comprises a center-side optical line terminal device and at least one user-side optical network unit device, wherein: the center-side optical line terminal device transmits, to a user-side optical network unit device, attribute information of a user-side optical network unit device to be connected to the center-side optical line terminal device and changes, based on the attribute information, a setting of a receiving means that receives a signal from outside; and the user-side optical network unit device transmits a response signal to the receiving means when the attribute information transmitted from the center-side optical line terminal device agrees with own attribute information of the user-side optical network unit device.

In a preferred aspect of the present invention, the center-side optical line terminal device comprises: a specifying means that specifies attribute information of the user-side optical network unit device to be connected to the center-side optical line terminal device; a first transmission means that transmits the attribute information, which is specified by the specifying means, to the user-side optical network unit device; a setting change means that changes the setting of the receiving means based on the attribute information; and a registration means that registers the user-side optical network unit device based on the response signal transmitted from the user-side optical network unit device.

In a preferred aspect of the present invention, the user-side optical network unit device comprises: a determination means that determines whether the attribute information transmitted from the center-side optical line terminal device agrees with the own attribute information of the user-side optical network unit device; and a second transmission means that transmits a response signal to the receiving means based on a determination result of the determination means.

In a preferred aspect of the present invention, the attribute information is a transmission speed of the user-side optical network unit device.

According to a second aspect of the present invention, a time division multiplexing transmission system comprises a center-side optical line terminal device and at least one user-side optical network unit device, wherein: the center-side optical line terminal device transmits, to a user-side optical network unit device, attribute information of a user-side optical network unit device to be connected to the center-side optical line terminal device and changes, based on the attribute information, a setting of a receiving means that receives a signal from outside; and the user-side optical network unit device transmits a response signal to the receiving means based on the attribute information transmitted from the center-side optical line terminal device and transmits, to the receiving means, attribute information indicating an own initial attribute of the user-side optical network unit device.

In a preferred aspect of the present invention, the center-side optical line terminal device comprises: a specifying means that specifies attribute information of the user-side optical network unit device to be connected to the center-side optical line terminal device; a first transmission means that transmits the attribute information, which is specified by the specifying means, to the user-side optical network unit device; a setting change means that changes the setting of the receiving means based on the attribute information; and a registration means that registers the user-side optical network unit device based on the response signal transmitted from the user-side optical network unit device.

In a preferred aspect of the present invention, the user-side optical network unit device comprises: an attribute change means that changes an attribute of the user-side optical network unit device based on the attribute information transmitted from the center-side optical line terminal device; an initial attribute information generation means that generates initial attribute information indicating an initial attribute of the user-side optical network unit device; and a second transmission means that transmits the response signal to the receiving means based on the attribute changed by the attribute change means and transmits the initial attribute information to the receiving means.

In a preferred aspect of the present invention, the attribute information is a transmission speed of the user-side optical network unit device.

In a third aspect of the present invention, a method of controlling a time division multiplexing transmission system comprising a center-side optical line terminal device and at least one user-side optical network unit device is a method comprising the steps of: transmitting, by the center-side optical line terminal device, to a user-side optical network unit device, attribute information of a user-side optical network unit device to be connected to the center-side optical line terminal device, and changing, by the center-side optical line terminal device, a setting of a receiving means that receives a signal from outside based on the attribute information; and transmitting, by the user-side optical network unit device, a response signal to the receiving means when the transmitted attribute information agrees with own attribute information of the user-side optical network unit device.

In a fourth embodiment of the present invention, a method of controlling a time division multiplexing transmission system comprising a center-side optical line terminal device and at least one user-side optical network unit device is a method comprising the steps of: transmitting, by the center-side optical line terminal device, to a user-side optical network unit device, attribute information of a user-side optical network unit device to be connected to the center-side optical line terminal device, and changing, by the center-side optical line terminal device, based on the attribute information, a setting of a receiving means that receives a signal from outside; and transmitting, by the user-side optical network unit device, a response signal to the receiving means based on the transmitted attribute information, and transmitting, by the user-side optical network unit device, to the receiving means, attribute information indicating an own initial attribute of the user-side optical network unit device.

### BRIEF EXPLANATION OF THE DRAWING

FIG. 1 is a block diagram schematically showing a configuration of a time division multiplexing transmission system according to a first embodiment of the present invention.

FIG. 2 is a block diagram showing a configuration of an OLT device in FIG. 1.

FIG. 3 is a block diagram showing a configuration of an ONU device in FIG. 1.

FIG. 4 is a flowchart of a registration process performed in the time division multiplexing transmission system in FIG. 1.

FIG. 5 is a block diagram schematically showing a configuration of an OLT device in a time division multiplexing transmission system according to a second embodiment of the present invention.

FIG. 6 is a block diagram schematically showing a configuration of an ONU device in the time division multiplexing transmission system according to the second embodiment.

FIG. 7 is a flowchart of a control method performed in the time division multiplexing transmission system according to the second embodiment.

FIG. 8 is a diagram schematically showing a configuration of a conventional time division multiplexing transmission system.

FIG. 9 is a diagram schematically showing a configuration of an OLT device in FIG. 8. Specifically, FIG. 9A shows a configuration of a receiver of the OLT device; FIG. 9B shows a configuration of a postamplifier (LA); and FIG. 9C shows a configuration of a preamplifier (TIA).

### MODE FOR CARRYING OUT THE INVENTION

The present invention will now be described in detail below with reference to the drawings showing preferred embodiments thereof.

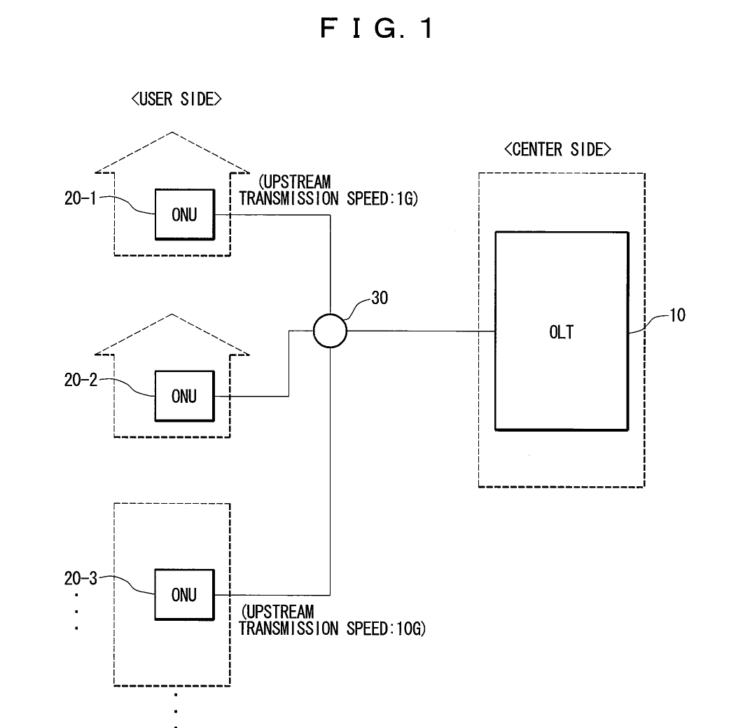

FIG. 1 is a block diagram schematically showing a configuration of a time division multiplexing transmission system according to a first embodiment of the present invention.

As shown in FIG. 1, the time division multiplexing transmission system comprises a center-side optical line terminal device (hereinafter referred to as the “OLT device”) 10 and a plurality of user-side optical network unit devices (hereinafter referred to as the “ONU devices”) 20-1, 20-2, 20-3 . . . , which are connected to the OLT device via an optical splitter 30 on a point-to-multipoint basis.

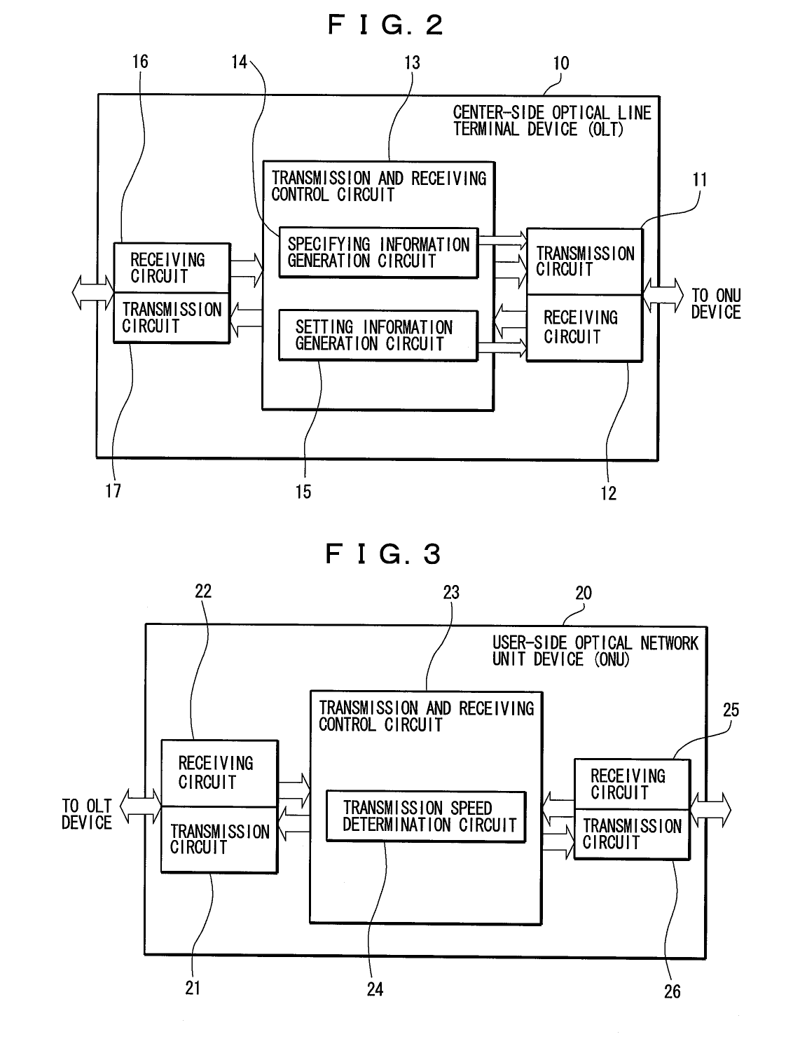

FIG. 2 is a block diagram showing a configuration of the OLT device 10 in FIG. 1. FIG. 3 is a block diagram showing a configuration of the ONU device 20 in FIG. 1.

As shown in FIG. 2, the OLT device 10 comprises a transmission circuit (first transmission means) 11 that transmits a signal to the ONU devices 20 and a receiving circuit (receiving means) 12 that receives a signal from the ONU devices. The OLT device 10 further comprises a transmission and receiving control circuit 13 connected to the transmission circuit 11 and the receiving circuit 12 for controlling transmission and reception of a signal by the transmission circuit 11 and the receiving circuit 12.

The transmission and receiving control circuit 13 comprises a transmission speed specifying information generation circuit (specifying means) 14. The transmission speed specifying information generation circuit 14 generates transmission speed specifying information (attribute information) for specifying the data transmission speed and transmits the transmission speed specifying information to the transmission circuit 11. The transmission and receiving control circuit 13 further comprises a setting information generation circuit (setting change means) 15. The setting information generation circuit 15 generates setting information based on a transmission speed contained in the transmission speed specifying information generated by the transmission speed specifying information generation circuit 14 and transmits the setting information to the receiving circuit 12.

Also, the OLT device 10 comprises a receiving circuit 16 that receives data from an upper-level network, e.g., a metro network, such as Gigabit Ethernet™, and a transmission circuit 17 that transmits data to the upper-level network. The receiving circuit 16 and the transmission circuit 17 are connected to the transmission and receiving control circuit 13, which controls transmission and reception of data by the receiving circuit 16 and the transmission circuit 17.

As shown in FIG. 3, the ONU device 20 comprises a transmission circuit (second transmission means) 21 that transmits a signal to the OLT device 10 and a receiving circuit 22 that receives a signal from the OLT device 10. The ONU device 20 further comprises a transmission and receiving control circuit 23 connected to the transmission circuit 21 and the receiving circuit 22 for controlling transmission and reception of a signal by the transmission circuit 21 and the receiving circuit 22.

The transmission and receiving control circuit 23 has a transmission speed determination circuit (determination means) 24 that determines whether the transmission speed contained in the transmission speed specifying information transmitted from the OLT device 10 agrees with the own transmission speed of the ONU device 20. When it is determined that the transmission speed contained in the transmission speed specifying information agrees with the own transmission speed of the ONU device 20, the transmission and receiving control circuit 23 transmits data at that transmission speed to the OLT device 10.

The ONU device 20 further comprises a receiving circuit 25 that receives data from a lower-level network, e.g., a PC terminal, and a transmission circuit 26 that transmits data to the lower-level network. The receiving circuit 25 and the transmission circuit 26 are connected to the transmission and receiving control circuit 23, which controls transmission and reception of data by the receiving circuit 25 and the transmission circuit 26.

In a time division multiplexing transmission system with the aforementioned configuration, to newly register an ONU device, the following registration process is performed:

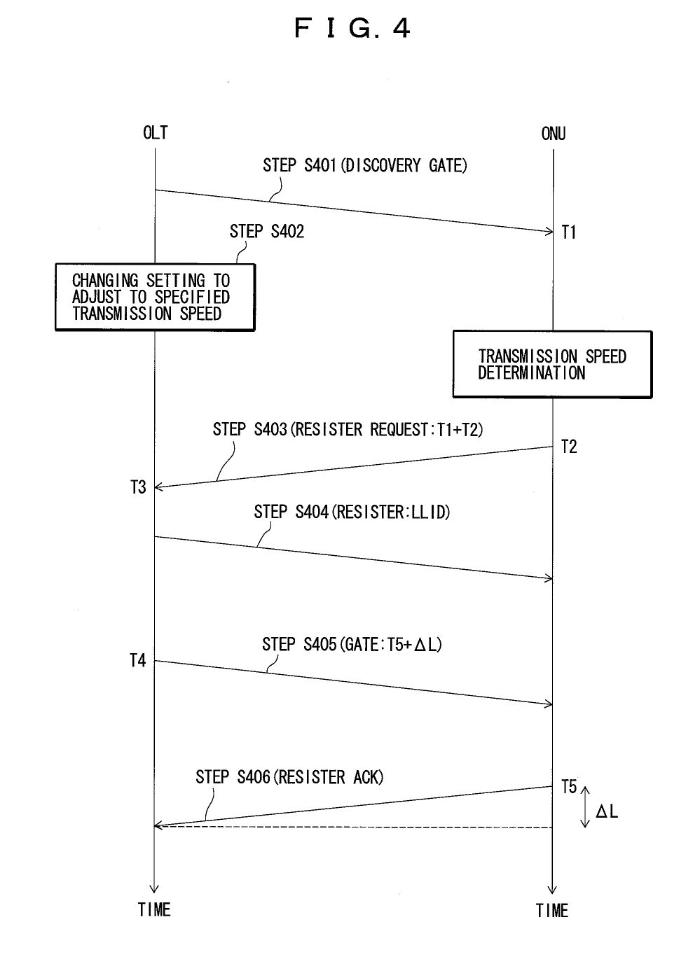

FIG. 4 is a flowchart of a control method performed in the time division multiplexing transmission system in FIG. 1.

In this embodiment, based on the discovery process used in the Gigabit Ethernet-Passive Optical Network (GE-PON), which is standardized as IEEE802.3, the flow of signals received by the OLT device at transmission speeds of 1.25 Gp/s (hereinafter referred to as “1 G”) and 10.3125 Gp/s (hereinafter referred to as “10 G”) is explained. The discovery process is a process for establishing a bi-directional network between the OLT device and ONU devices.

As shown in FIG. 4, first of all, to regularly confirm whether an ONU device has been newly added, the OLT device transmits at a predetermined timing, to the ONU devices, attribute specifying information that specifies the attribute of an ONU device which is permitted to respond (step S401). Specifically, when transmitting a discovery gate, which is a transmission permission frame for upstream signals, to the ONU devices, the OLT device specifies the transmission speed of the ONU device permitted to respond and transmits the transmission speed specifying information to the ONU devices. For example, at a certain timing, the transmission speed is specified so that only an ONU device with a transmission speed of upstream signals (signals from the ONU device to the OLT device) of 1 G is permitted to respond.

Next, at each timing of transmitting a transmission permission frame, the transmission and receiving control circuit of the OLT device transmits, to the receiving circuit in the OLT device, the attribute of an ONU device which is permitted to respond and changes the settings of the receiving circuit to optimum ones based on the attribute (step S402). Specifically, in the receiving circuit in the OLT device, the bandwidths of the preamplifier (TIA) and the postamplifier (LA), the reference clock setting of the Clock Data Recovery (CDR) circuit, which is disposed behind the TIA and LA, the setting for coding, and the like are changed based on the transmitted transmission speed information. For example, when the transmission speed information of an ONU device which is permitted to respond is 1 G, the above parameters are changed so that data transmitted at a transmission speed of 1 G can be received.

Meanwhile, upon reception of the transmission permission frame from the OLT device, the ONU device determines whether the attribute contained in the attribute specifying information specified by the OLT device agrees with its own preset attribute. When the attribute contained in the attribute specifying information agrees with its own attribute, a response signal is transmitted to the OLT device (step S403). Specifically, the ONU device determines whether the transmission speed specified by the OLT device agrees with its own transmission speed, and only when they are in agreement, the ONU device transmits a response frame called a Register Request to the OLT device. When they are not in agreement, the ONU device does not transmit a response frame to the OLT device. For example, when the transmission speed specified by the OLT device is 1 G, only the ONU device with an upstream signal transmission speed of 1 G transmits a response frame to the OLT device.

In this case, the ONU device that has received the transmission permission frame from the OLT device delays transmission of a response frame for a predetermined period of time (random delay) in order to prevent collision of its upstream data. The random delay, Dt, is given by Dt=T2−T1 (T2>T1) where T1 and T2 denote, respectively, the time when the ONU device receives the transmission permission frame and the time when the response signal is transmitted. The ONU device transmits, to the OLT device, T1 and T2 as time information together with a response frame.

Upon reception of the response frame from the ONU device, the OLT device transmits, to the ONU device, the Logical Link ID (LLID) together with a Register frame (step S404). Subsequently, the OLT device transmits, together with a Gate frame, time information T5 and a data transmission time period DL of the next upstream signal (step S405). The time information T5 and the data transmission time period DL are calculated based on the time information T1 and T2 transmitted together with the response frame as well as on the time information T3 indicating when the response frame is received.

Upon reception of the Gate frame, the ONU device transmits a Register Ack frame to the OLT device during the data transmission time period DL, which starts at the time T5 (step S406).

Upon reception of the Register Ack frame from the ONU device, the OLT device registers the ONU device to the system based on the Register Ack frame (registration means), followed by terminating the process.

When the OLT device at another timing sets, to 10 G, the transmission speed of an ONU device permitted to respond and transmits the transmission speed specifying information to the ONU devices, only the ONU device with an upstream signal transmission speed of 10 G transmits a response frame to the OLT device. Also, when at still another timing the OLT device sets, to a predetermined speed, the transmission speed of an ONU device permitted to respond and transmits the transmission speed specifying information to the ONU devices, only the ONU device whose upstream signal transmission speed is the predetermined speed transmits a response frame to the OLT device. Even when ONU devices with not less than three transmission speeds coexist in the system, ONU devices with any one of the transmission speeds can be registered.

As explained above, according to this embodiment, the OLT device specifies the transmission speed of an ONU device to be connected with itself, transmits the specified transmission speed to the ONU devices, and changes the settings of the receiving circuit 12 based on that transmission speed. Meanwhile, the ONU device transmits a response frame to the receiving circuit 12 when the transmission speed transmitted from the transmission circuit 11 agrees with its own transmission speed. Since the OLT device can in advance recognize the transmission speed of a signal transmitted from the ONU device, it does not have to perform determination of the signal after reception thereof, whereby the time required for establishing synchronization can be reduced. Since the rate of data transmitted per unit time can be increased, the transmission efficiency can be enhanced. In addition, as a differential output of a preamplifier (TIA) does not need to be split by a receiving circuit, deterioration of receiving sensitivity can be restrained.

As the OLT device does not need to have a circuit for determining the transmission speed of a signal and changes the settings of the receiving circuit 12 at a timing of transmitting a transmission permission frame, an increase in the number of components of the OLT device due to a gross increase in the transmission speed can be prevented. As a result, an increase in the cost, size, and power consumption can be prevented.

As the OLT device always specifies the timing of reception, the OLT device can in advance recognize the transmission speed of a signal received by the receiving circuit 12. Accordingly, the settings of ONU devices that have been registered can be optimized.

A time division multiplexing transmission system according to this embodiment is applicable to a system in which conventional ONU devices also exist. In this case, another response permission frame is provided, and a signal for determining that the aforementioned response permission frame received by a conventional ONU device is invalid is used, whereby the registration process can be performed only for ONU devices according to this embodiment.

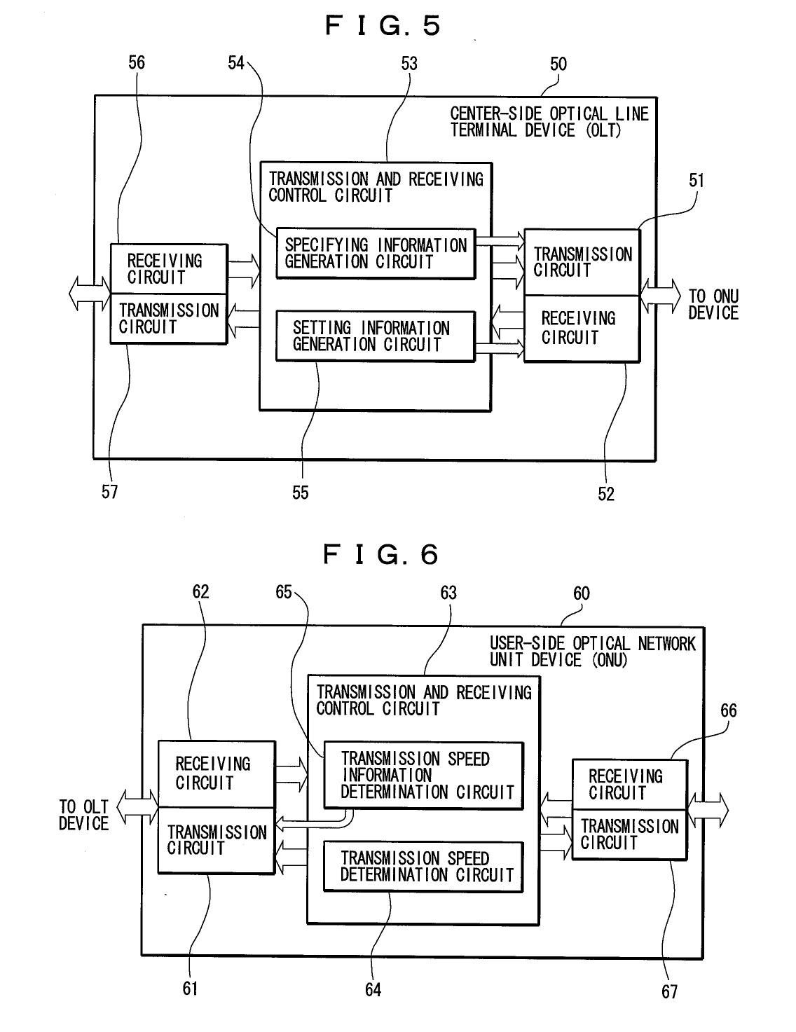

FIG. 5 is a block diagram schematically showing a configuration of an OLT device in a time division multiplexing transmission system according to a second embodiment of the present invention. FIG. 6 is a block diagram schematically showing a configuration of an ONU device in the time division multiplexing transmission system according to the second embodiment. The time division multiplexing transmission system according to this embodiment comprises an OLT device 50 and a plurality of ONU devices 60-1, 60-2, 60-3 . . . , which are connected to the OLT device via an optical splitter 30 on a point-to-multipoint basis.

As shown in FIG. 5, the OLT device 50 comprises a transmission circuit (first transmission means) 51 that transmits a signal to the ONU device 60 and a receiving circuit (receiving means) 52 that receives a signal from the ONU device. The OLT device 50 further comprises a transmission and receiving control circuit 53 connected to the transmission circuit 51 and the receiving circuit 52 for controlling transmission and reception of a signal by the transmission circuit 51 and the receiving circuit 52.

The transmission and receiving control circuit 53 comprises a transmission speed specifying information generation circuit (specifying means) 54. The transmission speed specifying information generation circuit 54 generates transmission speed specifying information (attribute information) for specifying a data transmission speed and transmits the transmission speed specifying information to the transmission circuit 51. The transmission and receiving control circuit 53 further comprises a setting information generation circuit (setting change means) 55. The setting information generation circuit 55 generates setting information based on the transmission speed contained in the transmission speed specifying information generated by the transmission speed specifying information generation circuit 54 and transmits the setting information to the receiving circuit 52.

The OLT device 50 further comprises a receiving circuit 56 that receives data from an upper-level network, e.g., a metro network, such as Gigabit Ethernet™, and a transmission circuit 57 that transmits data to the upper-level network. The receiving circuit 56 and the transmission circuit 57 are connected to the transmission and receiving control circuit 53, which controls transmission and reception of data by the receiving circuit 56 and the transmission circuit 57.

As shown in FIG. 6, the ONU device 60 comprises a transmission circuit (second transmission means) 61 that transmits a signal to the OLT device 50 and a receiving circuit 62 that receives a signal from the OLT device 50. The ONU device 60 further comprises a transmission and receiving control circuit 63 connected to the transmission circuit 61 and the receiving circuit 62 for controlling transmission and reception of a signal by the transmission circuit 61 and the receiving circuit 62.

The transmission and receiving control circuit 63 comprises a transmission speed changing circuit (attribute changing means) 64. The transmission speed changing circuit 64 changes the transmission speed of an upstream signal based on the transmission speed specifying information transmitted from the OLT device 50. The transmission and receiving control circuit 63 further comprises an initial transmission speed information generation circuit (initial attribute information generation circuit) 65. The initial transmission speed information generation circuit 65 generates initial transmission speed information that indicates the initial (original) transmission speed of the ONU device 60 and transmits the initial transmission speed information to the transmission circuit 61.

The ONU device 60 further comprises a receiving circuit 66 that receives data from a lower-level network, e.g., a PC terminal, and a transmission circuit 67 that transmits data to the lower-level network. The receiving circuit 66 and the transmission circuit 67 are connected to the transmission and receiving control circuit 63, which controls transmission and reception of data by the receiving circuit 66 and the transmission circuit 67.

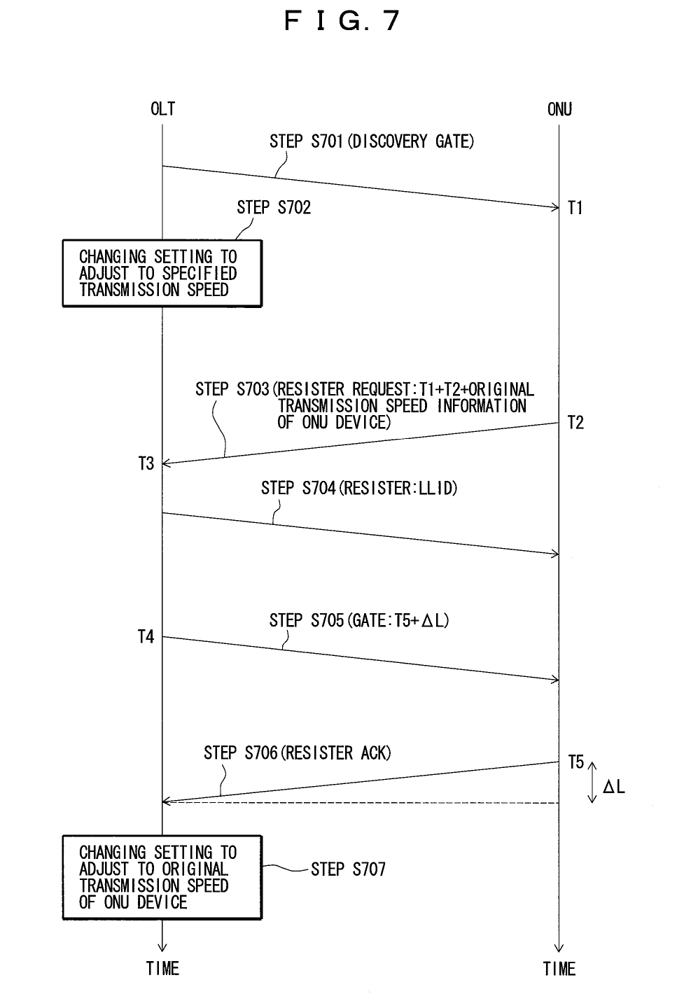

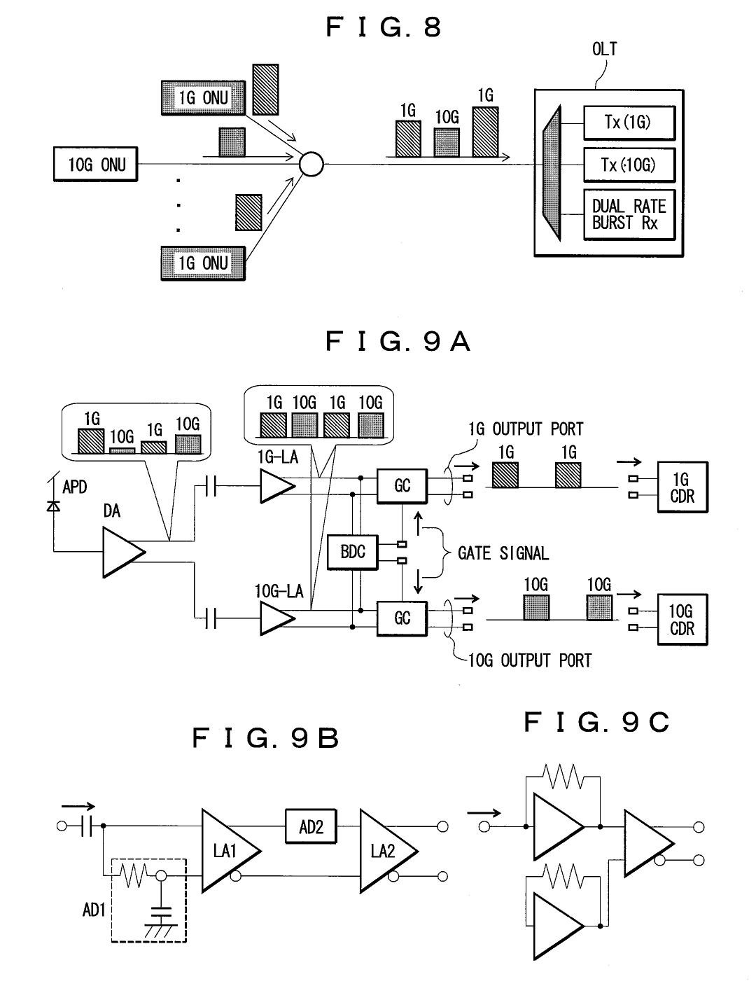

FIG. 7 is a flowchart of a registration process performed in the time division multiplexing transmission system according to the second embodiment. In this embodiment, based on the discovery process used in the GE-PON, which is standardized as IEEE802.3, the flow of signals received by the OLT device at transmission speeds of 1.25 Gp/s (hereinafter referred to as “1 G”) and 10.3125 Gp/s (hereinafter referred to as “10 G”) is explained. The discovery process is a process for establishing a bi-directional network between the OLT device and ONU devices.

As shown in FIG. 7, first of all, to regularly confirm whether an ONU device has been newly added, the OLT device transmits at a predetermined timing, to the ONU devices, attribute specifying information that specifies the attribute of an ONU device which is permitted to respond (step S701). Specifically, when transmitting a discovery gate, which is a transmission permission frame for upstream signals, to the ONU devices, the OLT device specifies a transmission speed of the ONU device permitted to respond and transmits the transmission speed specifying information to the ONU devices. For example, at a certain timing, the transmission speed of upstream signals (signals from the ONU device to the OLT device) is specified to be 1 G.

Next, at each timing of transmitting a transmission permission frame, the transmission and receiving control circuit of the OLT device transmits, to the receiving circuit in the OLT device, the attribute of an ONU device which is permitted to respond and changes the settings of the receiving circuit to optimum ones based on the attribute (step S702). Specifically, in the receiving circuit in the OLT device, the bandwidths of the preamplifier (TIA) and the postamplifier (LA), the reference clock setting of the Clock Data Recovery (CDR) circuit, which is disposed behind the TIA and LA, the setting for coding, and the like are changed based on the transmission speed information. This transmission speed information is setting information transmitted from the setting information generation circuit 55. For example, when the specified transmission speed is 1 G, the above parameters are changed so that data transmitted at a transmission speed of 1 G can be received.

Meanwhile, upon reception of the transmission permission frame from the OLT device, the ONU device transmits a response frame called Register Request to the OLT device at the transmission speed specified by the OLT device (step S703). Also, the ONU device transmits, to the OLT device, initial transmission speed information indicating its own initial transmission speed (actually used upstream signal transmission speed) together with a response frame. For example, when the transmission speed specified by the OLT device is 1 G and the initial transmission speed of the ONU device is 10 G, a response frame is transmitted at a transmission speed of 1 G, and the initial transmission speed of “10 G” is transmitted to the OLT device as initial transmission speed information.

In this case, the ONU device that has received the transmission permission frame from the OLT device delays transmission of a response frame for a predetermined period of time (random delay) in order to prevent collision of its upstream data. The random delay, Dt, is given by Dt=T2−T1 (T2>T1) where T1 and T2 denote, respectively, the time when the ONU device receives the transmission permission frame and the time when the response signal is transmitted. The ONU device transmits, to the OLT device, T1 and T2 as time information together with a response frame.

Upon reception of the response frame from the ONU device, the OLT device transmits, to the ONU device, the Logical Link ID (LLID) together with a Register frame (step S704). Subsequently, the OLT device transmits, together with a Gate frame, time information T5 and a data transmission time period DL of the next upstream signal (step S705). The time information T5 and the data transmission time period DL are calculated based on the time information T1 and T2 transmitted together with the response frame as well as on the time information T3 indicating when the response frame was received.

Upon reception of the Gate frame from the OLT device, the ONU device transmits a Register Ack frame to the OLT device during the data transmission time period DL, which starts at the time T5 (step S706).

Upon reception of the Register Ack frame from the ONU device, the OLT device registers the ONU device to the system based on the Register Ack frame (registration means). Then the OLT device changes the settings of the receiving circuit to optimum ones so that data is receivable at the original transmission speed of the ONU device contained in the transmission speed information transmitted from the ONU device (step S707), followed by terminating the process . For example, when the transmission speed specified by the OLT device is 1 G and the initial transmission speed of the ONU device is 10 G, the settings of the receiving circuit 52 are changed so that data with a transmission speed of 10 G is receivable after the ONU device is registered.

As explained above, according to this embodiment, the OLT device specifies the transmission speed of an ONU device to be connected with itself, transmits the specified transmission speed to the ONU devices, and changes the settings of the receiving circuit 52 based on that transmission speed. Meanwhile, the ONU device transmits a response frame to the receiving circuit 52 at the specified transmission speed and transmits initial transmission speed information, which indicates its initial transmission speed, to the OLT device, whereby the same effects as those of the first embodiment can be produced.

Since the OLT device can in advance recognize the transmission speed of a signal transmitted from an ONU device, it can change the settings of the receiving circuit 52 to ones that are optimum for the transmission speed. In general, the lower the transmission speed, the higher the allowable transmission loss may be. For example, even when an ONU device capable of high-speed transmission and reception experiences trouble during system operation and an increase in transmission loss and a transmission error occur, minimal communications are made possible by setting lower the transmission speed of the ONU device.

According to this embodiment, when newly registering an ONU device to the time division multiplexing transmission system, the lowest transmission speed for ONU devices of the system can be used to transmit a signal from the ONU device to the OLT device. It is thereby possible to perform minimal communications in the whole system.

According to the above embodiments, the transmission speed of upstream signals transmitted from ONU devices is 1 G or 10 G, but it is not limited thereto. Other transmission speeds can be used optionally.

Also, according to the above embodiments, the time division multiplexing transmission system comprises one OLT device and a plurality of ONU devices connected to the OLT device via an optical splitter on a point-to-multipoint basis, but it is not limited thereto. The system may comprise one OLT device and at least one ONU device connected to the OLT device via an optical splitter on a point-to-multipoint basis.

According to the above embodiments, the network system is the GE-PON, but it is not limited thereto. The system may be the PON or the WDM-TDM PON. Also, the PON may be the Passive Double Star (PDS).

### INDUSTRIAL APPLICABILITY

According to the time division multiplexing transmission system and the controlling method of the present invention, a center-side optical line terminal device transmits, to user-side optical network unit devices, attribute information of the user-side optical network unit device to be connected to the center-side optical line terminal device. Also, the center-side optical line terminal device changes, based on the attribute information, the settings of a receiving means that receives a signal from outside. When the attribute information transmitted from the center-side optical line terminal device agrees with its own attribute information, the user-side optical network unit device transmits a response signal to the receiving means of the center-side optical line terminal device. Accordingly, the transmission efficiency can be enhanced while restraining deterioration of receiving sensitivity, and an increase in the cost, size, and power consumption can be prevented.

According to the time division multiplexing transmission system and the controlling method of the present invention, a center-side optical line terminal device transmits, to user-side optical network unit devices, attribute information of a user-side optical network unit device to be connected to the center-side optical line terminal device. Also, the center-side optical line terminal device changes, based on the attribute information, the settings of a receiving means that receives a signal from outside. The user-side optical network unit device transmits, to the receiving means, a response signal based on the attribute information transmitted from the center-side optical line terminal device and transmits, to the receiving means, initial attribute information that indicates its own initial attribute of the user-side optical network unit device. The same effects as the aforementioned effects can be produced accordingly.

### EXPLANATION OF THE REFERENCE NUMERALS

10 center-side optical line terminal device (OLT device)

11, 17 transmission circuit

12, 16 receiving circuit

13 transmission and receiving control circuit

14 transmission speed specifying information generation circuit

15 setting information generation circuit

20 user-side optical network unit device (ONU device)

21, 26 transmission circuit

22, 25 receiving circuit

23 transmission and receiving control circuit

24 transmission speed determination circuit

30 optical splitter

What is claimed is:

1. A time division multiplexing transmission system comprising a center-side optical line terminal device and at least one user-side optical network unit device, wherein:
said center-side optical line terminal device transmits, to a user-side optical network unit device, attribute information of a user-side optical network unit device to be connected to said center-side optical line terminal device and changes, based on said attribute information, a setting of a receiving means that receives a signal from outside; and
said user-side optical network unit device transmits a response signal to said receiving means when said attribute information transmitted from said center-side optical line terminal device agrees with own attribute information of said user-side optical network unit device.

2. The time division multiplexing transmission system according to claim 1, wherein:
said center-side optical line terminal device comprises:
a specifying means that specifies attribute information of said user-side optical network unit device to be connected to said center-side optical line terminal device;
a first transmission means that transmits said attribute information, which is specified by said specifying means, to said user-side optical network unit device;
a setting change means that changes said setting of said receiving means based on said attribute information; and
a registration means that registers said user-side optical network unit device based on said response signal transmitted from said user-side optical network unit device.

3. The time division multiplexing transmission system according to claim 1, wherein:
said user-side optical network unit device comprises:
a determination means that determines whether said attribute information transmitted from said center-side optical line terminal device agrees with said own attribute information of said user-side optical network unit device; and
a second transmission means that transmits a response signal to said receiving means based on a determination result of said determination means.

4. The time division multiplexing transmission system according to any one of claims 1 to 3, wherein:
said attribute information is a transmission speed of said user-side optical network unit device.

5. A time division multiplexing transmission system comprising a center-side optical line terminal device and at least one user-side optical network unit device, wherein:
said center-side optical line terminal device transmits, to a user-side optical network unit device, attribute information of a user-side optical network unit device to be connected to said center-side optical line terminal device and changes, based on said attribute information, a setting of a receiving means that receives a signal from outside; and
said user-side optical network unit device transmits a response signal to said receiving means based on said attribute information transmitted from said center-side optical line terminal device and transmits, to said receiving means, attribute information indicating an own initial attribute of said user-side optical network unit device.

6. The time division multiplexing transmission system according to claim 5, wherein:
said center-side optical line terminal device comprises:
a specifying means that specifies attribute information of said user-side optical network unit device to be connected to said center-side optical line terminal device;
a first transmission means that transmits said attribute information, which is specified by said specifying means, to said user-side optical network unit device;
a setting change means that changes said setting of said receiving means based on said attribute information; and
a registration means that registers said user-side optical network unit device based on said response signal transmitted from said user-side optical network unit device.

7. The time division multiplexing transmission system according to claim 5, wherein:
said user-side optical network unit device comprises:
an attribute change means that changes an attribute of said user-side optical network unit device based on said attribute information transmitted from said center-side optical line terminal device;
an initial attribute information generation means that generates initial attribute information indicating an initial attribute of said user-side optical network unit device; and
a second transmission means that transmits said response signal to said receiving means based on said attribute changed by said attribute change means and transmits said initial attribute information to said receiving means.

8. The time division multiplexing transmission system according to any one of claims 5 to 7, wherein:
said attribute information is a transmission speed of said user-side optical network unit device.

9. A method of controlling a time division multiplexing transmission system comprising a center-side optical line terminal device and at least one user-side optical network unit device, the method comprising the steps of:
transmitting, by said center-side optical line terminal device, to a user-side optical network unit device, attribute information of a user-side optical network unit device to be connected to said center-side optical line terminal device, and changing, by said center-side optical line terminal device, based on said attribute information, a setting of a receiving means that receives a signal from outside; and
transmitting, by said user-side optical network unit device, a response signal to said receiving means when said transmitted attribute information agrees with own attribute information of said user-side optical network unit device.

10. A method of controlling a time division multiplexing transmission system comprising a center-side optical line terminal device and at least one user-side optical network unit device, the method comprising the steps of:
transmitting, by said center-side optical line terminal device, to a user-side optical network unit device, attribute information of a user-side optical network unit device to be connected to said center-side optical line terminal device, and changing, by said center-side optical line terminal device, based on said attribute information, a setting of a receiving means that receives a signal from outside; and
transmitting, by said user-side optical network unit device, a response signal to said receiving means based on said transmitted attribute information, and transmitting, by said user-side optical network unit device, to said receiving means, attribute information indicating an own initial attribute of said user-side optical network unit device.
